(19) United States
(12) Patent Application Publication
(10) Pub. No.: US 2024/0101828 A1
(43) Pub. Date: Mar. 28, 2024

(54) POLYESTER EMULSION FOR MODIFYING ASPHALT

(71) Applicant: KAO CORPORATION, Tokyo (JP)

(72) Inventor: Hiroki KAKIUCHI, Wakayama-shi, Wakayama (JP)

(73) Assignee: KAO CORPORATION, Tokyo (JP)

(21) Appl. No.: 18/273,290

(22) PCT Filed: Jan. 21, 2022
(86) PCT No.: PCT/JP2022/002183

§ 371 Date: Jul. 20, 2023

(30) Foreign Application Priority Data
Jan. 21, 2021 (JP) 2021-008102

(51) Int. Cl. C08L 95/00; C08G 63/672; C08J 3/05; E01C 7/26; E01C 11/24

(52) U.S. Cl. CPC C08L 95/005; C08G 63/672; C08J 3/05; E01C 7/265; E01C 11/24; C08J 2367/02; C08L 2201/52

(57) ABSTRACT

The present invention relates to [1] a polyester emulsion for modifying asphalt that contains polyester particles having a volume median particle diameter (D₅₀) of 20 nm or more and 500 nm or less and water, [2] a method for producing the polyester emulsion for modifying asphalt of the above [1], the method including a step of adding an aqueous medium to a molten polyester having a weight average molecular weight of 2,000 to 100,000, and [3] an asphalt emulsion composition containing an asphalt emulsion and the polyester emulsion of the above [1].

### FIELD OF THE INVENTION

The present invention relates to a polyester emulsion for modifying asphalt, a method for producing the same, and an asphalt emulsion composition.

### BACKGROUND OF THE INVENTION

Asphalt pavement using an asphalt mixture has been performed for paving driveways, parking spaces, cargo yards, sidewalks, etc. because of relatively easy construction and a short period of time from beginning of paving works to traffic start. Since performance in durability and the like is required for asphalt pavement, it is proposed to modify an asphalt with a polyester to increase the performance of asphalt pavement.

Asphalt has a high viscosity at normal temperature, resulting in poor workability. Thus, for ensuring a desired workability at normal temperature without heat, an asphalt emulsion in which an asphalt is dispersed in water to reduce the apparent viscosity is used.

PTL 1 (JP H09-59354 A) discloses, as an additive for asphalt emulsion and an asphalt composition that can develop a strength equal to or higher than that of a heating-type asphalt, can further increase waterproofness, and can also control the strength developing rate, an additive for asphalt emulsion, the additive containing a specific binder and a specific hardener composition, and an asphalt composition that contains the additive for asphalt emulsion and an asphalt emulsion.

Furthermore, various asphalt-free compositions that can achieve pavement at normal temperature are proposed.

PTL 2 (JP 2005-126998M discloses, as a composition for paving a road which has a sufficient strength, rapidly exhibits a strength, and can form or repair a paved body in an efficient manner, a composition for paving a road, the composition containing an aqueous dispersion in which a resin (A) having a specific acid value is neutralized with a basic compound and a silane coupling agent having a specific structure, and forming a binder material for an aggregate or a surface layer of a paved body in road pavement.

### SUMMARY OF THE INVENTION

The present invention relates to a polyester emulsion for modifying asphalt, the polyester emulsion containing polyester particles having a volume median particle diameter (D₅₀) of 20 nm or more and 500 nm or less and water.

### DETAILED DESCRIPTION OF THE INVENTION

Asphalt pavement has a problem of advanced degradation due to ultraviolet rays in long-term exposure to sunlight, resulting in cracking. This problem is particularly serious in a region subjected to high-intensity sunlight. When asphalt pavement is degraded, repair of the pavement becomes necessary. Repair of the pavement has resulted in increased maintenance costs and significant influence on car traffic. Thus, asphalt pavement superior in weather resistance which undergoes small degradation by ultraviolet rays is required.

In particular, from the viewpoint of energy saving, easy laying, and the like, it is required that asphalt pavement superior in weather resistance can be laid through normal-temperature pavement.

The technique described in PTL 1 is insufficient in the weather resistance of an asphalt.

PTL 2 does not specifically disclose a composition containing an asphalt, and is not intended to increase weather resistance of asphalt pavement.

The present invention relates to a polyester emulsion for modifying asphalt for achieving asphalt pavement superior in weather resistance, a method for producing the same, and an asphalt emulsion composition superior in weather resistance.

The present inventors have found that an asphalt modified with a polyester emulsion for modifying asphalt, the polyester emulsion containing a specific polyester particles and water, is suppressed in degradation by ultraviolet rays and is increased in weather resistance.

Specifically, the present invention provides the following [1] to [3].

[1] A polyester emulsion for modifying asphalt, the polyester emulsion containing polyester particles having a volume median particle diameter (D₅₀) of 50 nm or more and 500 nm or less and water.
[2] A method for producing the polyester emulsion for modifying asphalt according to the above [1], the method including the following step 1:

step 1: a step of adding an aqueous medium to a molten polyester.

[3] An asphalt emulsion composition containing an asphalt emulsion and the polyester emulsion according to the above [1].

The present invention provides a polyester emulsion for modifying asphalt for achieving asphalt pavement superior in weather resistance, a method for producing the same, and an asphalt emulsion composition superior in weather resistance.

### [Polyester Emulsion for Modifying Asphalt]

The polyester emulsion for modifying asphalt of the present invention contains polyester particles having a volume median particle diameter (D₅₀) of 20 nm or more and 500 nm or less and water.

The reason why the effect of the present invention is achieved is not clear, but it has been found that, when a polyester emulsion for modifying asphalt contains specific polyester particles, the weather resistance of the resulting asphalt pavement is increased.

The present invention also includes the following aspect:

a polyester emulsion for modifying asphalt, the polyester emulsion containing a polyester having a weight average molecular weight of 2,000 or more and 100,000 or less and water.

In this aspect, the volume median particle diameter (D₅₀) of the polyester particles is preferably 50 nm or more and 500 nm or less.

The polyester emulsion for modifying asphalt of the present invention is an O/W-type emulsion obtained by dispersing polyester particles in an aqueous medium.

The polyester particles contain as a constituting component a polyester in an amount of preferably 95% by mass or more, more preferably 97% by mass or more, and further preferably 99% by mass or more. In one of preferred aspects of the present invention, the polyester particles are substantially constituted only of a polyester.

The aqueous medium is a dispersion medium that contains at least water and in which water occupies the highest proportion by mass. The water content of the aqueous medium is, from the viewpoint of weather resistance, preferably 60% by mass or more, more preferably 75% by mass or more, and further preferably 90% by mass or more, and 100% by mass or less.

Examples of a component other than water include organic solvents that is soluble in water, for example, alkyl alcohols having 1 or more and 5 or less carbon atoms, such as methanol and ethanol; dialkyl ketones having 3 or more and 5 or less carbon atoms, such as acetone and methyl ethyl ketone; and a cyclic ether, such as tetrahydrofuran.

In one of preferred aspects of the present invention, the aqueous medium is substantially constituted only of water.

The solid content of the polyester in the polyester emulsion for modifying asphalt is, from the viewpoint of weather resistance, preferably 20% by mass or more, more preferably 30% by mass or more, and further preferably 40% by mass or more, and, from the viewpoint of emulsifiability, is preferably 70% by mass or less, more preferably 60% by mass or less, and further preferably 50% by mass or less.

The volume median particle diameter (D₅₀) of the polyester particles in the polyester emulsion for modifying asphalt is, from the viewpoint of weather resistance, 20 nm or more and 500 nm or less, preferably 30 nm or more, more preferably 40 nm or more, further preferably 50 nm or more, further preferably 60 nm or more, and further preferably 70 nm or more, and is preferably 400 nm or less, more preferably 300 nm or less, and further preferably 200 nm or less.

The volume median particle diameter (D₅₀) as used herein means a particle diameter that gives a cumulative volume frequency of 50% as calculated from the smaller particle diameter side on the basis of the volume fraction. The volume median particle diameter (D₅₀) can be determined by a method described in Examples given later.

The polyester emulsion for modifying asphalt can contain a surfactant. The content of the surfactant relative to 100 parts by mass of the polyester is preferably 5 parts by mass or less, more preferably 1 part by mass or less, and the surfactant may substantially be not contained.

When the polyester emulsion for modifying asphalt contains a surfactant, the surfactant is preferably contained in an aqueous medium which is a dispersion medium as a dispersant. As the surfactant, a surfactant contained in an asphalt emulsion described later can be suitably used.

From the viewpoint of weather resistance, the polyester emulsion for modifying asphalt can contain a plasticizer. Examples of the plasticizer include aliphatic esters, for example, a monohydric alcohol ester of a fatty acid, a monohydric alcohol ester of a polybasic acid, and a fatty acid ester of a polyhydric alcohol, such as a fatty acid ester of glycerol. Among them, a monohydric alcohol ester of a polybasic acid, such as acetyl tributyl citrate (ATBC), is exemplified.

The content of the plasticizer is, relative to 100 parts by mass of the polyester, preferably 1 part by mass or more, more preferably 2 parts by mass or more, and further preferably 10 parts by mass or more, and is preferably 100 parts by mass or less, more preferably 50 parts by mass or less, and further preferably 30 parts by mass or less.

When the polyester emulsion for modifying asphalt contains a plasticizer, the plasticizer is preferably insoluble in water and is contained in the polyester particles.

From the viewpoint of weather resistance, the polyester emulsion for modifying asphalt has a glass transition point, as measured with a dried product obtained through lyophilization of the polyester emulsion, of preferably 60° C. or lower, more preferably 20° C. or lower, and further preferably 0° C. or lower.

The glass transition point of a lyophilized product can be determined by a method described in Examples given later.

### <Polyester>

The polyester that constitutes the polyester particles contains an alcohol component-derived structural unit and a carboxylic acid component-derived structural unit, and is obtained by subjecting a carboxylic acid component and an alcohol component to polycondensation reaction.

One polyester can be used alone or two or more polyesters can be used in combination.

Properties and the like of the alcohol component, the carboxylic acid component, and the polyester will be described below.

The “alcohol component-derived structural unit” in the polyester, as used herein, means a structure obtained by removing a hydrogen atom from a hydroxy group of an alcohol component, and the “carboxylic acid component-derived structural unit” means a structure obtained by removing a hydroxy group from a carboxy group of a carboxylic acid component.

The “carboxylic acid component” is a concept including, not only the carboxylic acid, but also the anhydride which decomposes in a reaction to produce the acid, and an alkyl ester of the carboxylic acid. When the carboxylic acid component is an alkyl ester of the carboxylic acid, the number of carbon atoms of the alkyl group that is the alcohol residue of the ester is not included in the number of carbon atoms of the carboxylic acid component.

### (Alcohol Component)

Examples of the alcohol component include an aliphatic diol, an aromatic diol, a trihydric or higher and octahydric or lower polyhydric alcohol, and a polyalkylene glycol. One of the alcohol components can be used alone or two or more thereof can be used in combination.

Examples of the aliphatic diol include aliphatic diols having 2 or more and 20 or less carbon atoms, such as ethylene glycol, 1,2-propanediol, 1,3-propanediol, 1,4-butanediol, 1,5-pentanediol, 1,6-hexanediol, 1,4-butenediol, 1,3-butanediol, neopentyl glycol, 1,10-decanediol, and 1,12-dodecanediol.

Examples of the aromatic diol include bisphenol A and an alkylene oxide adduct of bisphenol A. The aromatic diol is preferably an alkylene oxide adduct of bisphenol A.

An example of the trihydric or higher and octahydric or lower polyhydric alcohol is glycerol.

Examples of the polyalkylene glycol include homopolymers, such as polyethylene glycol, polypropylene glycol, and polybutylene glycol, and a copolymer of two or more selected from ethylene glycol, propylene glycol, and butylene glycol. The polyalkylene glycol is preferably a homopolymer, and more preferably polyethylene glycol.

The number average molecular weight of the polyalkylene glycol is, from the viewpoint of emulsifiability, preferably 150 or more, more preferably 300 or more, further preferably 500 or more, and further preferably 700 or more, and from the viewpoint of weather resistance, is preferably 5,000 or less, more preferably 3,000 or less, and further preferably 2,000 or less.

The number average molecular weight of the polyalkylene glycol is a value determined through measurement by gel permeation chromatography (GPC method), followed by conversion using monodispersed polyethylene glycols having known molecular weights as standard substances.

Specifically, the number average molecular weight can be measured under the following conditions.
Columns: TSK PWXL+G4000PWXL+G2500PWXL (all from TOSOH CORPORATION)
Column temperature: 40° C.
Detector: RI or UV (210 nm)
Eluent: 0.2 mol/L phosphate buffer/acetonitrile (9/1)
Flow rate: 1.0 mL/min
Injection: 0.1 mL
Standard substances: monodispersed polyethylene glycols

When the alcohol component of the polyester contains a polyalkylene glycol, a preferred content of the polyalkylene glycol is, from the viewpoint of emulsifiability, in 100% by mass of the alcohol component, preferably 15% by mass or more, more preferably 18% by mass or more, and further preferably 20% by mass or more, and from the viewpoint of weather resistance, preferably 40% by mass or less, more preferably 35% by mass or less, and further preferably 30% by mass or less.

When the alcohol component of the polyester contains a polyalkylene glycol, a preferred content of the polyalkylene glycol is, from the viewpoint of emulsifiability, in 100% by mole of the alcohol component, preferably 2% by mole or more, more preferably 5% by mole or more, and further preferably 8% by mole or more, and from the viewpoint of weather resistance, preferably 35% by mole or less, more preferably 20% by mole or less, and further preferably 15% by mole or less.

From the viewpoint of weather resistance, the alcohol component preferably contains an alkylene oxide adduct of bisphenol A, more preferably contains an alkylene oxide adduct of bisphenol A represented by the following formula (I).

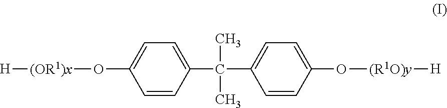

[In the formula, OR¹ and R¹O represent an alkylene oxide, R¹ represents an alkylene group having 2 or 3 carbon atoms, x and y represent a positive number that indicates an average number of moles of alkylene oxide added, and the sum of x and y is preferably 1 or more, and more preferably 1.5 or more, and is preferably 16 or less, more preferably 8 or less, and further preferably 4 or less.]

Examples of the alkylene oxide adduct of bisphenol A represented by the formula (I) include a propylene oxide adduct of bisphenol A [2,2-bis(4-hydroxyphenyl)propane] and an ethylene oxide adduct of bisphenol A.

The content of the alkylene oxide adduct of bisphenol A in the alcohol component is, from the viewpoint of weather resistance, based on 100% by mole of the alcohol component, preferably 65% by mole or more, more preferably 80% by mole or more, and further preferably 90% by mole or more, and is preferably 100% by mole or less, more preferably 98% by mole or less, and further preferably 95% by mole or less. It is considered that, when the content of the alkylene oxide adduct of bisphenol A is within the above range, the performance of the polyester to absorb ultraviolet rays is increased to suppress absorption of ultraviolet rays by the asphalt, resulting in a superior weather resistance.

The alcohol component may contain a monohydric aliphatic alcohol. The number of carbon atoms of the monohydric aliphatic alcohol is, from the viewpoint of emulsifiability, preferably 12 or more, and more preferably 14 or more, and from the viewpoint of weather resistance, is preferably 20 or less, and more preferably 18 or less.

Examples of the monohydric aliphatic alcohol include monohydric aliphatic alcohols having 12 or more and 20 or less carbon atoms, such as lauryl alcohol, myristyl alcohol, palmityl alcohol, and stearyl alcohol.

The content of the monohydric aliphatic alcohol is, from the viewpoint of weather resistance, based on 100% by mole of the alcohol component, preferably 20% by mole or less, and more preferably 15% by mole or less.

### (Carboxylic Acid Component)

Examples of the carboxylic acid component include an aliphatic dicarboxylic acid, an aromatic dicarboxylic acid, and a tribasic or higher and hexabasic or lower polybasic carboxylic acid. One of the carboxylic acid components can be used alone or two or more thereof can be used in combination.

Examples of the aliphatic dicarboxylic acid include aliphatic dicarboxylic acids having 4 or more and 14 or less carbon atoms, such as succinic acid, suberic acid, azelaic acid, sebacic acid, dodecanedioic acid, tetradecanedioic acid, and a succinic acid having an alkyl group or an alkenyl group as a side chain.

Examples of the aromatic dicarboxylic acid include terephthalic acid, isophthalic acid, naphthalene dicarboxylic acid, anthracene dicarboxylic acid, and phenanthrene dicarboxylic acid. Among them, the aromatic dicarboxylic acid is preferably one or more selected from terephthalic acid and isophthalic acid, and more preferably terephthalic acid.

Examples of the tribasic or higher and hexabasic or lower polybasic aromatic carboxylic acid include trimellitic acid, naphthalene tricarboxylic acid, and pyromellitic acid.

From the viewpoint of weather resistance, the carboxylic acid component preferably contains at least one selected from an aliphatic dicarboxylic acid and an aromatic dicarboxylic acid, more preferably an aromatic dicarboxylic acid.

The total content of the at least one selected from an aliphatic dicarboxylic acid and an aromatic dicarboxylic acid in the carboxylic acid component is preferably 65% by mole or more, more preferably 80% by mole or more, and further preferably 95% by mole or more.

The carboxylic acid component may contain a monobasic aliphatic carboxylic acid. The number of carbon atoms of the monobasic aliphatic carboxylic acid is, from the viewpoint of emulsifiability, preferably 12 or more, and more preferably 14 or more, and from the viewpoint of weather resistance, is preferably 20 or less, and more preferably 18 or less.

Examples of the monobasic aliphatic carboxylic acid include monobasic aliphatic carboxylic acids having 12 or more and 20 or less carbon atoms, such as lauric acid, myristic acid, palmitic acid, stearic acid, and an alkyl (having 1 or more and 3 or less carbon atoms) ester of such an acid.

The content of the monobasic aliphatic carboxylic acid is, from the viewpoint of weather resistance, based on 100% by mole of the carboxylic acid component, preferably 20% by mole or less, and more preferably 15% by mole or less.

### (Preferred Aspect of Polyester)

A preferred aspect of the polyester contains:
an alcohol component-derived structural unit, the alcohol component containing
(a-1) a polyalkylene glycol having a number average molecular weight of 300 or more 5,000 or less in an amount of preferably 15% by mass or more, more preferably 18% by mass or more, and further preferably 20% by mass or more, and preferably 40% by mass or less, more preferably 35% by mass or less, and further preferably 30% by mass or less, and
(a-2) an alkylene oxide adduct of bisphenol A in an amount of preferably 65% by mole or more, more preferably 80% by mole or more, and further preferably 90% by mole or more, and preferably 100% by mole or less, more preferably 98% by mole or less, and further preferably 95% by mole or less; and
(b) a carboxylic acid component-derived structural unit, the carboxylic acid component containing one or more selected from terephthalic acid and isophthalic acid in a total content of preferably 65% by mole or more, more preferably 80% by mole or more, and further preferably 95% by mole or more.

### (Molar Ratio of Carboxylic Acid Component-Derived Structural Unit to Alcohol Component-Derived Structural Unit)

The molar ratio of the carboxylic acid component-derived structural unit to the alcohol component-derived structural unit [carboxylic acid component/alcohol component] is, from the viewpoint of weather resistance, preferably 0.6 or more, more preferably 0.65 or more, and further preferably 0.7 or more, and is preferably 1.5 or less, more preferably 1.3 or less, and further preferably less than 1.0.

### (Properties of Polyester)

The weight average molecular weight of the polyester is, from the viewpoint of weather resistance, preferably 2,000 or more, more preferably 2,200 or more, further preferably 2,500 or more, and further preferably 3,000 or more, and from the viewpoint of emulsifiability, is preferably 100,000 or less, more preferably 80,000 or less, further preferably 50,000 or less, and further preferably 30,000 or less.

The acid value of the polyester is, from the viewpoint of weather resistance, preferably 2 mgKOH/g or more, more preferably 5 mgKOH/g or more, and further preferably 10 mgKOH/g or more, and is preferably 70 mgKOH/g or less, more preferably 25 mgKOH/g or less, and further preferably 15 mgKOH/g or less.

The hydroxyl value of the polyester is, from the viewpoint of weather resistance, preferably 2 mgKOH/g or more, more preferably 10 mgKOH/g or more, and further preferably 20 mgKOH/g or more, and from the viewpoint of emulsifiability, is preferably 70 mgKOH/g or less, more preferably 50 mgKOH/g or less, and further preferably 40 mgKOH/g or less.

The weight average molecular weight, the acid value, and the hydroxyl value of the polyester can be measured by methods described in Examples. The weight average molecular weight, the acid value, and the hydroxyl value can be adjusted by the raw material monomer composition, molecular weight, amount of catalyst, or reaction conditions.

### (Degree of Neutralization)

From the viewpoint of emulsifiability, at least a part of the acid groups of the polyester can be neutralized. In this case, the degree of neutralization is preferably 10% by mole or more, more preferably 30% by mole or more, and further preferably 40% by mole or more, and is preferably 90% by mole or less, more preferably 80% by mole or less, and further preferably 70% by mole or less.

Here, the degree of neutralization (% by mole) can specifically be determined by the following formula. When the degree of neutralization is 100% by mole or less, the degree of neutralization has the same meaning as the equivalent of the neutralizer used.

Degree of neutralization (% by mole)=[{mass of neutralizer added (g)/equivalent of neutralizer}/[{acid value (mgKOH/g) of polyester×mass (g) of polyester}/(56×1,000)]]×100

An example of the neutralizer used for neutralizing the polyester is a basic substance. Examples of the basic substance include an alkali metal hydroxide, such as sodium hydroxide or potassium hydroxide; and a nitrogen-containing basic substance, such as ammonia, trimethyl amine, or diethanolamine, and, from the viewpoint of weather resistance, the neutralizer is preferably a nitrogen-containing basic substance, and more preferably ammonia.

### (Method for Producing Polyester)

The method for producing the polyester is not particularly limited, but, for example, the polyester can be produced by polycondensation of the alcohol component and the carboxylic acid component described above.

The amounts of the alcohol component and the carboxylic acid blended are such amounts that give a molar ratio of the carboxylic acid component-derived structural unit to the alcohol component-derived structural unit [carboxylic acid component/alcohol component] within the above numerical range.

The temperature of the polycondensation reaction is, from the viewpoint of reactivity, preferably 160° C. or higher, more preferably 190° C. or higher, and further preferably 200° C. or higher, and preferably 260° C. or lower, more preferably 250° C. or lower, and further preferably 240° C. or lower.

In the polycondensation reaction, from the viewpoint of reaction rate, an esterification catalyst can be used. An examples of the esterification catalyst is a tin(II) compound having no Sn—C bond, such as tin(II) di(2-ethylhexanoate). The amount of the esterification catalyst used is, from the viewpoint of reaction rate, relative to 100 parts by mass of the total amount of the alcohol component and the carboxylic acid component, preferably 0.01 part by mass or more, more preferably 0.1 part by mass or more, and further preferably 0.2 parts by mass or more, and is preferably 1.5 parts by mass or less, more preferably 1.0 parts by mass or less, and further preferably 0.6 parts by mass or less.

In the polycondensation reaction, in addition to the esterification catalyst, a co-catalyst can be used. An example of the co-catalyst is a pyrogallol compound, such as gallic acid. The amount of the co-catalyst used is, relative to 100 parts by mass of the total amount of the alcohol component and the carboxylic acid component, preferably 0.001 part by mass or more, more preferably 0.005 parts by mass or more, and further preferably 0.01 part by mass or more, and is preferably 0.15 parts by mass or less, more preferably 0.10 parts by mass or less, and further preferably 0.05 parts by mass or less.

### [Method for Producing Polyester Emulsion for Modifying Asphalt]

The polyester emulsion for modifying asphalt of the present invention can be produced by a known method for dispersing a polyester, and is preferably produced by a phase inversion emulsification method. Examples of the phase inversion emulsification method include a method in which an aqueous medium is added to a solution of a polyester in an organic solvent, followed by phase inversion emulsification and a method in which a molten polyester is added into an aqueous medium, followed by phase inversion emulsification. From the viewpoint of weather resistance, for example, the polyester emulsion for modifying asphalt can be produced by a production method including the following step 1:

step 1: a step of adding an aqueous medium to a molten polyester.

### (Step 1)

In the step 1, an aqueous medium is added to a molten polyester, followed by polyester phase inversion emulsification. Specifically, a molten polyester is added little by little to an aqueous medium while stirring the aqueous medium to invert the phase.

As the polyester, the above-mentioned polyesters can be used. In the step 1, the molten polyester preferably has a weight average molecular weight of 2,000 or more and 100,000 or less.

As an aqueous medium, the above-mentioned aqueous mediums can be used.

The temperature for melting the polyester is, from the viewpoint of emulsifiability, preferably 60° C. or higher, more preferably 80° C. or higher, and further preferably 90° C. or higher, and from the viewpoint of suppressing bumping of the aqueous phase, is preferably 160° C. or lower, more preferably 140° C. or lower, and further preferably 120° C. or lower.

The temperature of the aqueous medium added is, from the viewpoint of emulsifiability, preferably 10° C. or higher, more preferably 20° C. or higher, and further preferably 30° C. or higher, and is preferably 90° C. or lower, more preferably 80° C. or lower, and further preferably 60° C. or lower.

The polyester emulsion for modifying asphalt of the present invention can be used for modifying an asphalt by being mixed with the asphalt or an asphalt emulsion. Since the polyester emulsion for modification of the present invention can be used at a normal temperature, the polyester emulsion for modification can be suitably used in combination with an asphalt emulsion.

### [Asphalt Emulsion Composition]

The asphalt emulsion composition of the present invention contains an asphalt emulsion and the polyester emulsion for modification described above. Specifically, the asphalt emulsion composition of the present invention contains an asphalt emulsion and a polyester emulsion for modifying asphalt, the polyester emulsion containing polyester particles having a volume median particle diameter (D₅₀) of 20 nm or more and 500 nm or less and water.

### <Asphalt Emulsion>

An asphalt emulsion is obtained by stably dispersing fine particles of an asphalt in water using a surfactant. Conventionally, such an asphalt emulsion itself has been used, for example, not only for tack coat or prime coat in road pavement, but also in a spray material for a surface treatment method, such as, fog seal or chip seal. Examples of the asphalt emulsion include various asphalt emulsions for road described in Japan Industrial Standard JIS K-2208:2006, a rubberized asphalt emulsion of JEAAS standard (Japan Emulsified Asphalt Association Standard), and an asphalt emulsion modified with a rubber and/or a resin.

The asphalt emulsion generally contains and an aqueous solvent, and can contain a surfactant and an inorganic salt, as required.

The asphalt particles contain, as a constituting component, an asphalt in an amount of preferably 85% by mass or more, more preferably 90% by mass or more, and further preferably 95% by mass or more.

The solid content of the asphalt emulsion is, from the viewpoint of weather resistance, preferably 40% by mass or more, more preferably 50% by mass or more, and further preferably 55% by mass or more, and from the viewpoint of emulsifiability, is preferably 70% by mass or less, more preferably 67% by mass or less, and further preferably 65% by mass or less.

### (Asphalt)

As an asphalt that constitutes the asphalt particles, various asphalts can be used. Examples thereof include a straight asphalt which is a petroleum asphalt for pavement and a modified asphalt.

Straight asphalt refers to a residual bituminous substance obtained by subjecting crude petroleum to an atmospheric distillation apparatus, a vacuum distillation apparatus, or the like.

Examples of the modified asphalt include a blown asphalt; and an asphalt modified with a polymer material, such as a thermoplastic elastomer or a thermoplastic resin.

Examples of the thermoplastic elastomer include a styrene/butadiene/block copolymer (SBS), a styrene/isoprene/block copolymer (SIS), and an ethylene/vinyl acetate copolymer (EVA).

Examples of the thermoplastic resin include an ethylene/vinyl acetate copolymer, an ethylene/ethyl acrylate copolymer, a polyethylene, and a polypropylene.

Among them, a straight asphalt is preferred.

The degree of penetration of an asphalt, in particular, a straight asphalt is, from the viewpoint of emulsifiability, preferably 40 or more, more preferably 60 or more, and further preferably 80 or more, and from the viewpoint of pavement strength after laying, is preferably 250 or less, more preferably 230 or less, and further preferably 210 or less.

The degree of penetration is a measure of hardness of an asphalt. The degree of penetration is measured by a method defined in JIS K2207:2006. Under the testing conditions described in JIS K2207:2006, the case where the length of a specified needle vertically penetrating a sample at 25° C. is 0.1 mm is taken as a degree of penetration of 1.

The content of the asphalt is, based on the total mass of the asphalt emulsion, preferably 40% by mass or more, more preferably 50% by mass or more, and further preferably 60% by mass or more, and is preferably 80% by mass or less, and more preferably 70% by mass or less.

### (Surfactant)

The asphalt emulsion preferably contains a surfactant. Examples of the surfactant include a cationic surfactant, an anionic surfactant, an amphoteric surfactant, a nonionic surfactant, or a mixture thereof. From the viewpoint of emulsifiability, the surfactant is preferably a cationic surfactant or a nonionic surfactant, and more preferably a cationic surfactant.

As the cationic surfactant, a mineral acid salt, a lower carboxylic acid salt, or a quaternary ammonium salt of an amine, such as an alkyl amine, an alkyl polyamine, an amide amine, or an alkyl imidazoline can be exemplified.

Into the cationic surfactant, in terms of the form of the surfactant, for example, for the purpose of making the surfactant into a liquid form, a solvent, such as water, a lower alcohol, glycol, or polyoxyethylene glycol, a saccharide, such as glucose or sorbitol, a lower fatty acid, a lower amine, or a hydrotropic agent, such as p-toluenesulfonic acid or an ether carboxylic acid can be blended.

As the nonionic surfactant, a sorbitan ester, an alkylene oxide adduct of a sorbitan ester, an ethylene oxide adduct of a long-chain alcohol, an ethylene oxide adduct of an alkyl phenol, and an alkyl glycoside can be exemplified.

The content of the cationic surfactant is, in view of the economy, for achieving a superior storage stability, in a general use, based on the total mass of the asphalt emulsion, preferably 0.02% by mass or more, more preferably 0.05% by mass or more, and further preferably 0.10% by mass or more, and is preferably 3.0% by mass or less, more preferably 2.0% by mass or less, and further preferably 1.0% by mass or less.

The content of the nonionic surfactant is, in view of the economy, for achieving a superior storage stability, in a general use, based on the total mass of the asphalt emulsion, preferably 0.1% by mass or more, more preferably 0.5% by mass or more, and further preferably 1.0% by mass or more, and is preferably 5.0% by mass or less, more preferably 4.0% by mass or less, and further preferably 3.0% by mass or less.

When the asphalt emulsion contains a surfactant, the surfactant is preferably contained as a dispersant in an aqueous medium which is a dispersion medium.

### (Inorganic Salt)

From the viewpoint of emulsifiability, the asphalt emulsion can contain an inorganic salt. Examples of the inorganic salt include sodium chloride, potassium chloride, calcium chloride, and aluminum chloride, and the inorganic salt is preferably calcium chloride.

The content of the inorganic salt is, in a general use, relative to the mass of the produced asphalt emulsion, preferably 0.01% by mass or more, more preferably 0.03% by mass or more, and further preferably 0.05% by mass or more, and is preferably 3.0% by mass or less, more preferably 2% by mass or less, and further preferably 1% by mass or less.

When the asphalt emulsion contains an inorganic salt, the inorganic salt is preferably contained in an aqueous medium which is a dispersion medium.

### (Volume Median Particle Diameter (D₅₀) of Asphalt Emulsion)

The volume median particle diameter (D₅₀) of the asphalt emulsion particle in the asphalt emulsion is, from the viewpoint of weather resistance, preferably 1 μm or more, more preferably 2 μm or more, and further preferably 3 μm or more, and is preferably 50 μm or less, more preferably 40 μm or less, and further preferably 30 μm or less.

The volume median particle diameter (D₅₀) of the asphalt emulsion can be measured by the following method.
(i) Measurement apparatus: laser diffraction particle size analyzer “LA-920” (manufactured by HORIBA, Ltd.)
(ii) Measurement conditions: distilled water was added to the asphalt emulsion to adjust the concentration so that the particle diameters of 30,000 particles could be measured in 20 seconds. Then, 30,000 particles are measured to obtain the particle diameter distribution thereof. From the obtained particle diameter distribution, the volume median particle diameter (D₅₀) and the particle frequency of particle diameters of 500 nm or less are determined.

### (Method of Producing Asphalt Emulsion)

The asphalt emulsion can be produced by a known method. For example, the asphalt emulsion can be produced by mixing and emulsifying an asphalt, a surfactant, and an aqueous medium, and as required, an inorganic-containing salt with an emulsifier, such as a colloid mill, a Hurrell-type homogenizer, a homogenizer, or a line mixer.

The asphalt is emulsified in a heat-molten state. The heating temperature is generally preferably 120° C. or higher and 160° C. or lower.

### <Content of Polyester>

The content of the polyester in the asphalt emulsion composition is, from the viewpoint of weather resistance, relative to 100 parts by mass of the asphalt, preferably 1 part by mass or more, more preferably 2 parts by mass or more, and further preferably 3 parts by mass or more, and is preferably 40 parts by mass or less, more preferably 20 parts by mass or less, and further preferably 10 parts by mass or less. The asphalt emulsion and the polyester emulsion are preferably mixed so as to satisfy the above condition.

### <Particle Diameter Distribution of Asphalt Emulsion Composition>

The asphalt emulsion composition contains at least polyester particles and asphalt particles.

The particle diameter distribution of the asphalt emulsion composition preferably has two peaks respectively corresponding to the polyester particles and the asphalt particles. Preferred volume median particle diameters of the polyester particles and the asphalt particles are as described above.

The asphalt emulsion composition of the present invention can be used alone or in mixture with another additive or the like. For example, the asphalt emulsion composition can be suitably used alone for prime coat, tack coat, or the like. Alternatively, the asphalt emulsion composition can be suitably used with an aggregate, a filler, or the like mixed therewith for producing a mixture for pavement.

Since an asphalt is dispersed in a non-heated state in the asphalt emulsion composition of the present invention, the asphalt emulsion composition can be used even in a non-heated state preferably at 150° C. or lower, more preferably at 100° C. or lower, and further preferably at 50° C. or lower. Thus, the asphalt emulsion composition can be suitably used for normal temperature pavement of an asphalt.

### EXAMPLES

In the Preparation Examples, Production Examples, Examples, and Comparative Example, “parts” and “%” mean “parts by mass” and “% by mass” unless otherwise specified.

### (1) Method of Measuring Acid Value and Hydroxyl Value of Polyester

The acid value and the hydroxyl value of the polyester were measured based on the method of JIS K0070:1992. However, only the measurement solvent was changed from the mixed solvent of ethanol and ether defined in JIS K0070:1992 to the mixed solvent of acetone and toluene (acetone:toluene=1:1 (by volume)).

### (2) Method of Measuring Softening Point and Glass Transition Point of Polyester

### (i) Softening Point

Using a flow tester (“CFT-500D” manufactured by SHIMADZU CORPORATION), a load of 1.96 MPa was applied with a plunger to 1 g of a sample while heating the sample at a temperature rise rate of 6° C./minute to extrude the sample from a nozzle having a diameter of 1 mm and a length of 1 mm. The amount of lowering of the plunger of the flow tester was plotted relative to the temperature, and the temperature at which the half amount of the sample had flowed out was taken as the softening point.

### (ii) Glass Transition Point

Using a differential scanning calorimeter (“Q-100” manufactured by TA Instruments Japan Inc.), 0.01 to 0.02 g of a sample was weighed into an aluminum pan, was heated to 200° C., and was then cooled from the temperature to 0° C. at a temperature lowering rate of 10° C./minute. Next, while increasing the temperature to 150° C. at a temperature rise rate of 10° C./min, the calory was measured. A temperature at which an extension of a baseline in a region of the endothermic maximum peak temperature or lower was intersected with a tangential line having the maximum inclination of a curve in a region of from a rise-up portion of the peak to an apex of the peak was read as the glass transition point.

### (3) Method of Measuring Weight Average Molecular Weight of Polyester

A molecular weight distribution was measured by gel permeation chromatography (GPC) method obtained by the following method to determine the weight average molecular weight.

### (i) Preparation of Sample Solution

A sample was dissolved in tetrahydrofuran at 25° C. so as to give a concentration of 0.5 g/100 mL. Next, this solution was filtered with a fluororesin filter having a pore size of 0.2 μm (“DISMIC-25JP” manufactured by TOYO ROSHI KAISHA, LTD.) to remove insoluble matter, thus preparing a sample solution.

### (ii) Measurement of Molecular Weight

Using the following measurement apparatus and analytical columns, tetrahydrofurane as an eluent was allowed to flow at a flow rate of 1 mL per minute, and the columns were stabilized in a thermostatic chamber of 40° C. A sample solution 100 μL was injected therein to perform measurement. The molecular weight of the sample was calculated based on a previously created calibration curve. Here, as the calibration curve, one created using several monodispersed polystyrenes “A-500” (5.0×10²), “A-1000” (1.01×10³), “A-2500” (2.63×10³), “A-5000” (5.97×10³), “F-1” (1.02×10³), “F-2” (1.81×10⁴), “F-4” (3.97×10⁴), “F-10” (9.64×10⁴), “F-20” (1.90×10⁵), “F-40” (4.27×10⁵), “F-80” (7.06×10⁵), and “F-128” (1.09×10⁶) (all manufactured by TOSOH CORPORATION) as standard samples was used.

Measurement apparatus: “HLC-8220CPC” (manufactured by TOSOH CORPORATION)

Analytical columns: “GMHXL”+“G3000HXL” (manufactured by TOSOH CORPORATION)

### (4) Method of Measuring Glass Transition Point (Tg) of Lyophilized Product of Polyester Emulsion

### (i) Lyophilization

A polyester emulsion 20 g was weighed onto an aluminum dish, then, was placed in a shelf-type drier “DRC-1000” (manufactured by TOKYO RIKAKIKAI CO., LTD.) connected to a lyophilizer “FDU-2100” (manufactured by TOKYO RIKAKIKAI CO., LTD.) at a normal temperature and a normal pressure, and was kept at −25° C. for 1 hour. Then, the pressure was reduced to and held at 8.0 Pa at −10° C. for 9 hours. Then, the polyester emulsion was held at 25° C. for 5 hours, and was restored to a normal pressure to obtain a lyophilized product.

### (ii) Measurement of Glass Transition Point (Tg)

Using a differential scanning calorimeter “Q100” (manufactured by TA Instrument Japan Inc.), 0.01 to 0.02 g of a lyophilized product was weighed into an aluminum pan, was heated to 120° C., and was then cooled from the temperature to −50° C. at a temperature lowering rate of 10° C./minute. Subsequently, while increasing the temperature of the sample at a temperature rise rate of 10° C./min, the calory was measured. The temperature at which the extension of the baseline in the region of the endothermic maximum peak temperature or lower was intersected with the tangential line having the maximum inclination of a curve in a region of from a rise-up portion of the peak to the apex of the peak was read as the glass transition point.

### (5) Method of Measuring Volume Median Particle Diameter (D₅₀) of Polyester Emulsion

(i) Measurement apparatus: laser diffraction particle size analyzer “LA-960” (manufactured by HORIBA, Ltd.)
(ii) Measurement method: ion exchange water as a dispersion medium was added to a measurement cell, a sample was portionwise added, and the volume median particle diameter (D₅₀) was measured with an amount of the sample so as to give a transmittance of red light (transmittance (R)) and a transmittance of blue light (transmittance (B)) in the ranges shown in the following (v).
(iii) Apparatus conditions

(Measurement Cell) Flow Cell

(Sample)
LD real term (sample): 1.6
LD imaginary term (sample): 0
LED real term (sample): 1.6
LED imaginary term (sample): 0

(Dispersion Medium)
LD real term (dispersion medium): 1.333
LED real term (dispersion medium): 1.333

(Measurement Liquid)
Ultrasonic wave: OFF
Stirring: 2
Circulation: 5

### (iv) Dispersion Medium

Ion exchange water

### (v) Amount of Sample

An amount to give transmittances in the following ranges
Transmittance (R): 80 to 98%
Transmittance (B): 60 to 90%

### (6) Method of Measuring Solid Concentration in Polyester Emulsion and Asphalt Emulsion Composition

Using an infrared aquameter (“FD-230” manufactured by Kett Electric Laboratory Co. Ltd.), 5 g of a measurement sample was dried under conditions of a drying temperature of 150° C. and a measurement mode of 96 (monitoring time: 2.5 minutes, fluctuation range: 0.05%) to measure the water content (% by mass) of the measurement sample. The solid concentration was calculated according to the following formula.

Solid concentration (% by mass)=100−water content (% by mass)

### Production Examples 1 to 2 (Production of Polyesters (A1) to (A2))

Alcohol components and a carboxylic acid component shown in Table 1 were placed in a 5-liter four-neck flask equipped with a thermometer, a stainless steel stirring rod, a flow-down condenser, and a nitrogen introducing tube, 20 g of tin(II) di(2-ethylhexanoate) was added in a nitrogen atmosphere, was heated in a mantle heater to 225° C. over 3 hours, and after 225° C. was reached, a reaction was performed at 225° C. until a target acid value was reached, thereby obtaining polyesters (A1) to (A2). The results are shown in Table 1.

TABLE 1

| | | | Production Example | | | |
|---|---|---|---|---|---|---|
| | | | 1 | | 2 | |
| Type of polyester | | | A1 | | A2 | |
| Raw | Monomer | | Charged | Molar | Charged | Molar |
| material | composition | | amount | ratio | amount | ratio |
| monomer | | | (g) | *4 | (g) | *4 |
| | Alcohol | BPA-PO *1 | 2261 | 91 | 2330 | 93.1 |
| | component | PEG-1000 *2 | 220 | 3.1 | 165 | 2.3 |
| | | PEG-1540 *3 | 645 | 5.9 | 507 | 4.6 |
| | Carboxylic acid | Terephthalic acid | 874 | 74.2 | | |
| | component | Adipic acid | | | 999 | 95.7 |

| Mass ratio of PEG in all | 27.6 | 24.2 |
|---|---|---|
| alcohol components (%) | | |

| | | | |
|---|---|---|---|
| Properties | Acid value (mgKOH/g) | 12.0 | 20.5 |
| | Weight average molecular weight | 3400 | 5900 |

*1 BPA-PO: polyoxypropylene (2.2 mol) adduct of bisphenol A
*2 PEG-1000: “polyethylene glycol 1,000”, manufactured by FUJIFILM Wako Pure Chemical Corporation
*3 PEG-1540: “polyethylene glycol 1,540”, manufactured by FUJIFILM Wako Pure Chemical Corporation
*4 Moles relative to 100 moles of alcohol components (molar ratio)

### Production Example 3 (Production of Polyester (B1))

A polyoxypropylene adduct of a bisphenol, a polyoxyethylene adduct of a bisphenol, terephthalic acid, and dodecenylsuccinic anhydride shown in Table 2 were placed in a 5-liter four-neck flask equipped with a stainless steel stirring rod, a flow-down condenser, and a nitrogen introducing tube, 20 g of tin(II) cli(2-ethylhexanoate) and 2 g of gallic acid were added thereto in a nitrogen atmosphere, and the temperature was increased to 235° C. over 3 hours, After 235° C. was reached, the temperature was kept for 5 hours. Then, a reaction was performed at a reduced pressure of 8.0 kPa for 1 hour, and then the temperature was decreased to 210° C. Trimellitic anhydride was put therein at 210° C., and the temperature was kept at 210° C. for 1 hour. A reaction was performed at a reduced pressure of 8.0 kPa, and the reaction was then continued until the softening point shown in Table 2 was reached, thereby obtaining a polyester (B1). The results are shown in Table 2.

TABLE 2

| | | | Production | |
|---|---|---|---|---|
| | | | Example | |
| | | | 3 | |
| | | | Type of | |
| | | | polyester | |
| | | | B1 | |
| | | | Charged | Molar |
| | | | amount | ratio |
| | Monomer composition | | (g) | *3 |
| Raw | Alcohol | BPA-PO *1 | 1448 | 50 |
| material | component | BPA-EO *2 | 1345 | 50 |
| monomer | Carboxylic acid | Terephthalic acid | 783 | 57 |
| | component | Dodecenylsuccinic | 106 | 5 |
| | | anhydride | | |
| | | Trimellitic | 318 | 20 |
| | | anhydride | | |

| | | |
|---|---|---|
| Properties | Softening point (° C.) | 123.1 |
| | Acid value (mgKOH/g) | 18.3 |
| | Hydroxyl value (mgKOH/g) | 36.7 |
| | Glass transition point (° C.) | 64.2 |
| | Weight average molecular weight | 30000 |

*1: BPA-PO: Polyoxypropylene (2.2 mol) adduct of bisphenol A
*2: BPA-EO: Polyoxyethylene (2.2 mol) adduct of bisphenol A
*3: Moles relative to 100 moles of alcohol components (molar ratio)

### Production Example 4 (Production of Asphalt Emulsion (AE1))

As an aqueous phase, 7.2 g (0.3% by mass relative to theoretical yield) of a cationic surfactant (“ASFIER N100L” manufactured by Quimi-Kao S.A. de C.V.; amine mixture), 780 g of ion exchange water and 2.4 g (0.1% by mass relative to theoretical yield) of calcium chloride were mixed, the mixture was adjusted to pH2.0 with 1.0 M hydrochloric acid, and the total weight of the aqueous phase was adjusted to 840 g with ion exchange water. Into a colloid mill, 840 g of the aqueous phase heated to 50° C. and 1,560 g of a straight asphalt (manufactured by COSMO OIL Co., Ltd., degree of penetration 150-200) heated to 140° C. were simultaneously put to obtain an asphalt emulsion (AE1). The colloid mill was set so as to give a particle diameter of 14 μm. The results are shown in Table 3.

### Production Example 5 (Production of Asphalt Emulsion (AE2))

As an aqueous phase, 48.0 g (2.0% by mass relative to theoretical yield) of a nonionic surfactant (“EMULGEN 4085” manufactured by Kao Corporation; nonionic surfactant, polyoxyethylene myristyl ether), 780 g of ion exchange water, and 2.4 g (0.1% by mass relative to theoretical yield) of calcium chloride were mixed, and the total weight of the aqueous phase was adjusted to 840 g. Into a colloid mill, 840 of the aqueous phase heated to 50° C. and 1,560 g of a straight asphalt (manufactured by COSMO OIL Co., Ltd., degree of penetration 150-200) heated to 140° C. were simultaneously put to obtain an asphalt emulsion (AE2). The colloid mill was set so as to give a particle diameter of 17 μm. The results are shown in Table 3.

TABLE 3

| | | | Surfactant | | | |
|---|---|---|---|---|---|---|
| | | | | Content | CaCl₂ | Solid |
| | Asphalt | | | (% by | (% by | content |
| | emulsion | Asphalt | Type | mass) *1 | mass) *2 | (%) |
| Production | AE1 | Straight | Cationic | 0.3 | 0.1 | 62.3 |
| Example 4 | | asphalt | | | | |
| Production | AE2 | Straight | Nonionic | 2 | 0.1 | 62.1 |
| Example 5 | | asphalt | | | | |

*2 Content of surfactant relative to theoretical yield (% by mass)
*3 Content of CaCl₂ relative to theoretical yield (% by mass)

### Example 1-1 (Production of Polyester Emulsion (C1))

Into a 3-liter container equipped with a stirrer (“Three-one Motor BL300” manufactured by Shinto Scientific Co., Ltd.), a reflux condenser, a thermometer, and a nitrogen introducing tube, 1,728 g of ion exchange water was placed, and was heated to 40° C. Next, with keeping at 40° C. and stirring at 200 r/min, 672 g of a polyester (A1) heated to 100° C. was slowly added dropwise to the aqueous phase. The rate of dropwise addition was controlled so that the temperature in the system was 40 to 45° C. After the dropwise addition was completed, the system was heated to 55° C., and under a reduced pressure of 15 KPa, water was removed out of the system until a target solid content was reached. Then, the system was cooled to 35° C. or lower, and was subjected to filtration with a mesh wire netting of an aperture of 2 mm, thereby obtaining a polyester emulsion (C1). The results are shown in Table 4.

### Example 1-2 (Production of Polyester Emulsion (C2))

A polyester emulsion (C2) was obtained in the same manner as in Example 1-1 except for using a polyester (A2) as the polyester and adding 5.4 g of a surfactant (“QUOATAMIN 86W” manufactured by Kao Corporation; cationic surfactant) to the aqueous phase. The results are shown in Table 4.

### Example 1-3 (Production of Polyester Emulsion (C3))

Into a 3-liter container equipped with a stirrer “Three-one Motor BL300” (manufactured by Shinto Scientific Co., Ltd.), a reflux condenser, a dropping funnel, a thermometer, and a nitrogen introducing tube, 500 g of the polyester (B1) and 500 g of methyl ethyl ketone were placed, and the polyester was dissolved at 60° C. over 3 hours. After cooling to 35° C., a 25% aqueous ammonia was added to the solution so as to give a degree of neutralization of 60% by mole relative to the acid value of the polyester, followed by stirring for 60 minutes.

Next, with keeping at 35° C. and stirring at 200 r/min, 1,082 g of deionized water was added over 120 minutes to perform phase inversion emulsification. Then, 100 g of a plasticizer (“Tributyl 0-Acetylcitrate” manufactured by Tokyo Chemical Industry Co., Ltd.) was added, followed by stirring for 30 minutes. After heating to 60° C., methyl ethyl ketone was removed by distillation under a reduced pressure to obtain an aqueous dispersion. The aqueous dispersion was cooled to 30° C. with stirring, and then, the solid concentration was adjusted to 40% by mass with deionized water, followed by filtration with a 150-mesh wire netting, thereby obtaining a polyester emulsion (C3). The results are shown in Table 4.

### Example 1-4 (Production of Polyester Emulsion (C4))

Into a 3-liter container equipped with a stirrer “Three-one Motor BL300” (manufactured by Shinto Scientific Co., Ltd.), a reflux condenser, a dropping funnel, a thermometer, and a nitrogen introducing tube, 500 g of the polyester (B1) and 500 g of methyl ethyl ketone were placed, and the polyester was dissolved at 60° C. over 3 hours. After cooling to 35° C., a 25% aqueous ammonia was added to the solution so as to give a degree of neutralization of 60% by mole relative to the acid value of the polyester, followed by stirring for 60 minutes.

Next, with keeping at 35° C. and stirring at 200 r/min, 1,082 g of deionized water was added over 120 minutes to perform phase inversion emulsification. Then, 25 g of a plasticizer (“Tributyl 0-Acetylcitrate” manufactured by Tokyo Chemical Industry Co., Ltd.) was added, followed by stirring for 30 minutes. After heating to 60° C., methyl ethyl ketone was removed by distillation under a reduced pressure to obtain an aqueous dispersion. Then, the aqueous dispersion was cooled to 30° C. with stirring, and then, the solid concentration was adjusted to 40% by mass with deionized water, followed by filtration with a 150-mesh wire netting, thereby obtaining a polyester emulsion (C4). The results are shown in Table 4.

TABLE 4

| | | Polyester | | | | | | | | | Glass |
|---|---|---|---|---|---|---|---|---|---|---|---|
| | | | Charged | Surfactant | Neutralizer | MEK | Water | Plasticizer | Particle | | transition |
| | | | amount | (parts by | (parts by | (parts by | (parts by | (parts by | diameter | Solid | point of |
| | Polyester | | (parts by | mass) | mass) | mass) | mass) | mass) | (D₅₀) | content | dried product |
| | emulsion | Type | mass) | *1 | *2 | *3 | *4 | *5 | (nm) | (%) | (° C.) |
| Example 1-1 | C1 | A1 | 100 | — | — | — | 260 | — | 103.4 | 40.7 | −10.6 |
| Example 1-2 | C2 | A2 | 100 | QUARTAMIN | — | — | 260 | — | 171.6 | 35.2 | −21.5 |
| | | | | 86W | | | | | | | |
| | | | | 0.80 | | | | | | | |
| Example 1-3 | C3 | B1 | 100 | — | NH3 *6 | 100 | 280 | ATBC *7 20 | 153.1 | 39.7 | 10.2 |
| | | | | | 1.4 | | | | | | |
| Example 1-4 | C4 | B1 | 100 | — | NH3 *6 | 100 | 280 | ATBC *7 5 | 153.1 | 39.7 | 51.1 |
| | | | | | 1.4 | | | | | | |

*1 Charged amount of surfactant relative to 100 parts by mass of polyester (parts by mass)
*2 Charged amount of neutralizer relative to 100 parts by mass of polyester (parts by mass)
*3 Charged amount of methyl ethyl ketone (MEK) relative to 100 parts by mass of polyester (parts by mass)
*4 Charged amount of water relative to 100 parts by mass of polyester (parts by mass)
*5 Charged amount of plasticizer relative to 100 parts by mass of polyester (parts by mass)
*6 25% aqueous ammonia
*7 “Tributyl O-Acetylcitrate”, manufactured by Tokyo Chemical Industry Co., Ltd.

### Example 2-1 (Production of Asphalt Emulsion Composition (AP1))

Into a 500 mL stainless-steel beaker, 200 g of the asphalt emulsion (AE1) obtained in Production Example 4 was placed, and with stirring at room temperature at 100 rpm, 15.3 g of the polyester emulsion (C1) obtained in Example 1-1 was added thereto, followed by mixing for 3 minutes, thereby obtaining an asphalt emulsion composition (AP1).

The amount of the polyester emulsion (C1) added was such an amount that gave an amount of the polyester (A1) in the polyester emulsion (C1) of 5 parts by mass relative to 100 parts by mass of the asphalt in the asphalt emulsion (AE1).

### Examples 2-2 to 2-4 and Comparative Example 2-1

Asphalt emulsions (AP2) to (AP5) were obtained in the same manner as in Example 1 except for changing the conditions in Example 1 to conditions shown in Table 5.

The asphalt emulsion compositions (AP1) to (AP5) obtained in Examples and Comparative Example were used to evaluate the weather resistance according to the following method. The results are shown in Table 5.

### (Preparation of Sample for Evaluating Weather Resistance)

Each asphalt emulsion composition was placed on a disposable dish (“EMS/TEK500/600” manufactured by Anton Paar GmbH) in an amount of 3 g in terms of the solid, was evenly spread, and then, was dried in a high temperature drier at 60° C. for 3 days to obtain a sample for evaluating weather resistance.

### (Accelerated Test of Degradation by UV Irradiation)

The obtained sample for evaluating weather resistance was allowed to stand in a super accelerated weathering tester (“Super Xenon Weather Meter SX75” manufactured by Suga Test Instruments Co., Ltd.), and scanning was performed at a UV intensity of 120 W/m 2, an irradiation wavelength of 300 to 400 nm, a temperature in tank of 40° C., a humidity of 75%, a panel temperature of 65° C., and an irradiation time of 100 h, thereby performing an accelerated test of degradation by UV irradiation.

### (Measurement of Tan δ Before and After UV Irradiation)

For a sample before and after UV irradiation, a kinetic viscoelasticity was measured using a rotational rheometer (“MCR301” manufactured by Anton Paar GmbH).

Using a dedicated jig (“P-PTD200/62” manufactured by Anton Paar GmbH), onto a disposable dish (“EMS/TEK500/600” manufactured by Anton Paar GmbH) fixed to the rheometer, 1 g of the weather resistance sample heated to 120° C. was placed, and using a 25-mm disposable plane plate (“PP25” manufactured by Anton Paar GmbH), a kinetic viscoelasticity was measured at a gap of 1.0 mm, a strain of 0.1%, and a frequency of 1.0 Hz. A temperature control unit under the sample was used for controlling the temperature, and while cooling the sample from 120° C. to 0° C. at a temperature lowering rate of 5° C./minute, tan δ at 20° C. was measured.

The rate of change in tan δ was determined according to the following formula to evaluate the weather resistance. A rate of change closer to 100% indicates a smaller degree of degradation by ultraviolet ray irradiation and a more superior weather resistance. The test results are shown in Table 5.

Rate of change in tan δ=[tan δ after UV irradiation)/(tan δ before UV irradiation)]×100

TABLE 5

| | | | Polyester emulsion | | Evaluation of weather resistance | | |
|---|---|---|---|---|---|---|---|
| | | | | Polyester | | | Rate of |
| | Asphalt | | | content | tanδ | tanδ | change |
| | emulsion | Asphalt | | (parts by | before UV | after UV | in tanδ |
| | composition | emulsion | Type | mass) *1 | irradiation | irradiation | (%) *2 |
| Example 2-1 | AP1 | AE1 | C1 | 5 | 3.14 | 3.02 | 96.2 |
| Example 2-2 | AP2 | AE1 | C2 | 5 | 3.18 | 2.99 | 94.0 |
| Example 2-3 | AP3 | AE2 | C3 | 5 | 3.27 | 2.54 | 77.7 |
| Example 2-4 | AP4 | AE2 | C4 | 5 | 3.04 | 2.09 | 68.8 |
| Comparative | AP5 | AE1 | — | — | 3.64 | 1.13 | 31.0 |
| Example 2-1 | | | | | | | |

*1 Content of polyester relative to 100 parts by mass of asphalt (parts by mass: in terms of solid)
*2 (tanδ after irradiation/tanδ before irradiation) × 100

It is found from Table 5 that the asphalt emulsion compositions obtained in Examples 2-1 to 2-4 which contain the polyester emulsions obtained in Examples 1-1 to 1-4 are superior in weather resistance. Since the asphalt modified with the polyester emulsion for modifying asphalt of the present invention is superior in weather resistance, suppression in generation of cracking can be expected.

1. A polyester emulsion for modifying asphalt, the polyester emulsion comprising:
particles of a polyester, wherein the particles have a volume median particle diameter (D₅₀) of 20 nm or more and 500 nm or less, and
water,
wherein the polyester has an acid value of 2 mgKOH/g or more and 70 mgKOH/g or less.

2. The polyester emulsion for modifying asphalt according to claim 1, wherein the polyester has a weight average molecular weight of 2,000 or more and 100,000 or less.

3. The polyester emulsion for modifying asphalt according to claim 1, wherein the polyester comprises an alcohol component-derived structural unit, the alcohol component containing a polyalkylene glycol having a number average molecular weight of 150 or more and 3,000 or less.

4. The polyester emulsion for modifying asphalt according to claim 3, wherein the polyalkylene glycol is one or more selected from
(i) a homopolymer selected from a polyethylene glycol, a polypropylene glycol, and a polybutylene glycol, and
(ii) a copolymer of two or more selected from ethylene glycol, propylene glycol, and butylene glycol.

5. The polyester emulsion for modifying asphalt according to claim 3, wherein the polyalkylene glycol is contained in an amount of 15% by mass or more and 40% by mass or less based on 100% by mass of the alcohol component.

6. The polyester emulsion for modifying asphalt according to claim 1, wherein the polyester comprises an alcohol component-derived structural unit, the alcohol component containing an alkylene oxide adduct of bisphenol A in an amount of 65% by mole or more.

7. The polyester emulsion for modifying asphalt according to claim 1, wherein the polyester comprises a carboxylic acid-derived structural unit, the carboxylic acid containing one or more selected from terephthalic acid and isophthalic acid in an amount of 65% by mole or more.

8. (canceled)

9. The polyester emulsion for modifying asphalt according to claim 1, wherein the volume median particle diameter (D₅₀) is 50 nm or more.

10. A method for producing a polyester emulsion for modifying asphalt, wherein the polyester emulsion comprises:
particles of a polyester, wherein the particles have a volume median particle diameter (D 50) of 20 nm or more and 500 nm or less, and
water,
the method comprising
adding an aqueous medium to a molten polyester.

11. An asphalt emulsion composition comprising
an asphalt emulsion, and
a polyester emulsion for modifying asphalt, the polyester emulsion containing particles of a polyester, the particles having a volume median particle diameter (D₅₀) of 20 nm or more and 500 nm or less, and water.

12. The asphalt emulsion composition according to claim 11, wherein the polyester is contained in an amount of 1 part by mass or more and 40 parts by mass or less relative to 100 parts by mass of an asphalt.

13. The asphalt emulsion composition according to claim 11, wherein asphalt particles have a volume median particle diameter (D₅₀) of 1 μm or more and 50 μm or less.

14. The asphalt emulsion composition according to claim 11, wherein the asphalt emulsion composition comprises one or more surfactants selected from a cationic surfactant and a nonionic surfactant.

15. The asphalt emulsion composition according to claim 11,
wherein the polyester has an acid value of 2 mgKOH/g or more and 70 mgKOH/g or less.

16. The asphalt emulsion composition according to claim 11,
wherein the polyester comprises an alcohol component-derived structural unit, the alcohol component containing a polyalkylene glycol having a number average molecular weight of 150 or more and 3,000 or less, and
the polyalkylene glycol is contained in an amount of 15% by mass or more and 40% by mass or less based on 100% by mass of the alcohol component.

17. The asphalt emulsion composition according to claim 11,
wherein the polyester comprises an alcohol component-derived structural unit, the alcohol component containing an alkylene oxide adduct of bisphenol A in an amount of 65% by mole or more.

18. The asphalt emulsion composition according to claim 11,
wherein the polyester comprises a carboxylic acid-derived structural unit, the carboxylic acid containing one or more selected from terephthalic acid and isophthalic acid in an amount of 65% by mole or more.

19. The asphalt emulsion composition according to claim 11,
wherein the volume median particle diameter (D₅₀) of the particles of polyester is 50 nm or more.

20. A method for paving a road, the method comprising laying the asphalt emulsion composition for pavement according to claim 11 onto a road at 150° C. or lower.
